(19) United States
(12) Patent Application Publication
(10) Pub. No.: US 2009/0016943 A1
(43) Pub. Date: Jan. 15, 2009

(54) Flexible Mixing Surface

(76) Inventors: Paul Francis, Dandridge, TN (US); Maurice Rogers, Dandridge, TN (US)

Correspondence Address: KNOX PATENTS, P.O. BOX 30034, KNOXVILLE, TN, 37930-0034, US

(21) Appl. No.: 11/777,629

(22) Filed: Jul. 13, 2007

(51) Int. Cl. B01J 19/00

(52) U.S. Cl. 422/240; 422/129

(57) ABSTRACT

An apparatus for mixing a compound that hardens when cured, the apparatus allowing for rapid removal of the compound after hardening. A mixing pad is a thick, flexible sheet that has anti-adhesion properties. The mixing pad is supported by a support device that has a rigid support surface that maintains the planar configuration of the work surface of the pad. The support device includes means for securing the mixing pad to a support surface of the device. In one embodiment, the support device includes a compartment for storing the mixing pad. The compartment is also configured for being a mold to form the pad. In another embodiment, the support device has a support surface with protrusions that engage openings in the pad, thereby securing the pad to the support device.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a flexible mixing surface that provides for rapid cleanup and reuse. More particularly, this invention pertains to a flexible pad with a surface that allows mixing of a compound that cures to a hardened state. The pad is flexible and has anti-adhesive properties that allow for rapid removal of the hardened compound.

2. Description of the Related Art

Automobile repair shops commonly use body repair fillers, epoxy, and other materials applied to the bodies of vehicles when making repairs. These materials are a compound or mixture that is worked as a putty or a paste on a mixing board. Working the material typically includes mixing the compound if it is a two part mixture. It also includes kneading the compound on the mixing surface, typically with a putty knife, scraper, or spatula. When the material is mixed properly and has the correct consistency, the compound is applied to the vehicle with a putty knife or other tool, which spreads the compound over an area of the vehicle body. After the compound is applied and hardens on the vehicle, the hardened material is sanded and worked to a smooth finish. Working the hardened material creates dust and debris, which potentially contaminates exposed surfaces in the shop.

It is not uncommon for the automobile repair person to use scrap pieces of cardboard for a mixing surface. Cardboard is often readily available, although it often has dirt and grit on its surface. Any contamination on the mixing surface potentially affects the quality of the finished repair. Accordingly, it is desirable to use a clean surface to mix the compound.

An early attempt to provide a clean mixing surface is disclosed in U.S. Pat. No. 3,734,486, titled “Mixing board,” and issued to Peacy on May 22, 1973. A box of rolled wax paper provides a source of clean mixing surfaces as the wax paper is drawn from the roll over a board. After the compound is mixed and removed from the wax paper, the soiled wax paper is removed from the board and discarded, being replaced by fresh wax paper from the roll. The wax paper is thin and susceptible to buckling and tearing when a stiff or high viscosity compound is mixed and worked on the wax paper.

Another attempt to provide a mixing surface is disclosed in U.S. Pat. No. 4,538,726, titled Disposable mixing palette and container,” and issued to Pastva on Sep. 3, 1985. The Pastva device is a container that holds a plurality of prefabricated disposable palettes. The pallets are disclosed as being cardboard or pressed or molded fiberboard. The pallets are selectively removed from the container when needed and disposed after use.

Another type of mixing pallet is disclosed in U.S. Pat. No. 4,740,014, titled “Palette with disposable mixing surface for mixing blendable materials,” and issued to Holt on Apr. 26, 1988, and its continuation in part, U.S. Pat. No. 4,858,955, titled “Palette with disposable mixing surface for mixing blendable materials,” and issued to Holt on Aug. 22, 1989. A rigid, planar base supports a pad of disposable mixing sheets. The mixing sheets are thin and susceptible to buckling and tearing when a stiff or high viscosity compound is worked on the sheets. The base includes holes and cutouts that aid in gripping the base during mixing of the compound.

In the devices that use disposable sheets, it is not uncommon for the sheets to tear or rip when the compound is being worked during mixing, particularly if the compound is stiff or highly viscous. The disposable sheets are thin and typically only secured along one or more edges. As the putty knife kneads the material and pushes and pulls it across the surface of the sheet, the shear stress often is so great that the sheet is pulled from its support and buckles, if the sheet does not tear first.

### BRIEF SUMMARY OF THE INVENTION

According to one embodiment of the present invention, a reusable flexible mixing pad is provided. The mixing pad is a resilient material that is attached to a support device having a support surface. The pad is a thick, flexible material that has anti-adhesive properties. The support device has a rigid planar surface and an attachment mechanism for securing the pad to the support surface.

In one embodiment, the support device is a clipboard with a clamp. In one such embodiment, the clipboard is a storage-type clipboard that is dimensioned to store the mixing pad inside the clipboard when the pad is not in use. In another embodiment, the storage-type clipboard includes a compartment that provides both a mold for making the mixing pad and a storage compartment for the pad.

In another embodiment, the support device includes pegs that engage holes in the mixing pad, thereby securing the mixing pad to the support surface. The mixing pad has a plurality of indexing holes and the support surface includes corresponding protruding pegs that engage the indexing holes. The pad is secured to the support surface by the weight of the pad plus the pegs engaging the holes, thereby allowing the compound to be thoroughly mixed on the flexible mixing pad without the pad being displaced on the support surface.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a flexible mixing pad attached to one embodiment of a support device;

FIG. 2 is a side view of the flexible mixing pad with a cured compound;

FIG. 3 is a side view of the flexible mixing pad in a flexed state with the cured compound detached from the pad; and

FIG. 4 is an exploded perspective view of another embodiment of a flexible mixing pad and a support device.

### DETAILED DESCRIPTION OF THE INVENTION

An apparatus for mixing and working a compound that hardens or cures is disclosed. The apparatus is reusable and minimizes contamination of the compound.

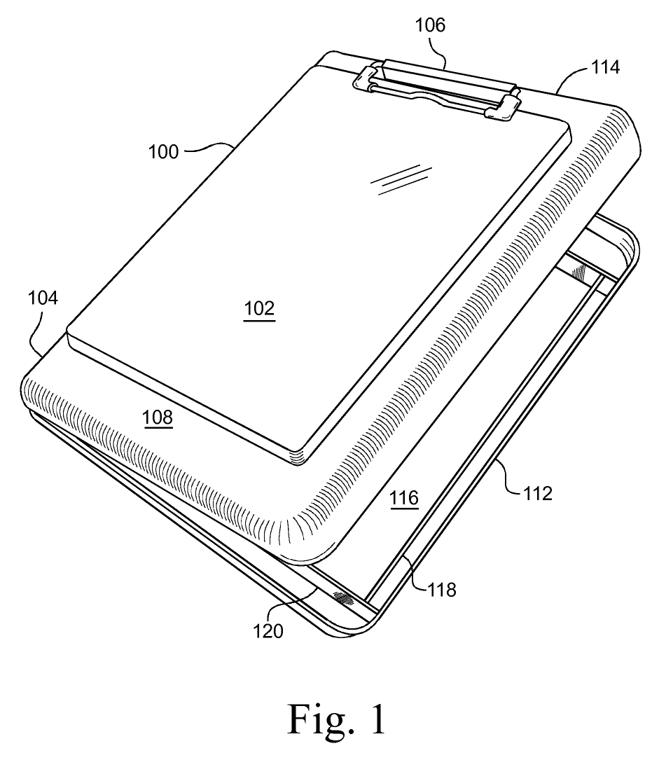

FIG. 1 illustrates a perspective view of one embodiment of a flexible mixing pad 100 attached to one embodiment of a support device 104. The mixing pad 100 is a solid, thick sheet with a working surface 102 that is substantially planar. The mixing pad 100 is reusable because the compound is readily removed after being worked and after it hardens. In particular, the mixing pad 100 is made of a material that is flexible, forms a smooth tough skin, is dimensionally stable, is anti-adhesive, has low chemical reactivity, is thermally stable, and repels water and other fluids. In one embodiment, the pad 100 has surfaces with a high coefficient of friction when adjacent to another smooth surface, such as the support surface 108 of the support device 104.

The smooth tough skin and dimensional stability properties of the mixing pad 100 prevents the pad 100 from buckling, tearing, and being gouged when the pad 100 is dimensioned with sufficient thickness. The anti-adhesive property prevents the compound from sticking to the pad 100 when it is being worked and after it hardens or cures, thereby allowing the compound to be readily removed from the pad 100 so the pad 100 can be reused. The low chemical reactivity and thermal stability properties of the pad 100 make the pad 100 suitable for use with a wide variety of compounds, including those that are caustic or have exothermic reactions. The property of being water and fluid repellant allows the pad 100 to be easily cleaned and prevents absorption of the compound when it is being worked.

In one embodiment, the mixing pad 100 is a solid planar sheet of silicone, or polymerized siloxane, having sufficient hardness and skin or surface toughness to withstand repeated application of a putty knife or other mixing tool. For example, a ½ inch thick mixing pad 100 of silicone has a smooth surface that resists cutting and gouging from a putty knife as the knife mixes a compound on the working surface 102. Also, the mixing pad 100 has sufficient stiffness and weight that the pad 100 remains in place on the support surface 108 and does not deform or buckle from the shear stress applied by the putty knife.

In one embodiment, the mixing pad 100 has approximate dimensions of 8×11 inches and is ½ inch thick. The mixing pad 100 is sufficiently thick that when a compound is mixed on the working surface 102, the mixing pad 100 maintains its shape and configuration with minimal distortion.

In the illustrated embodiment, the support device 104 is a storage-type clipboard 104 having an inside compartment 116 and a clamp 106 on the rigid outside surface 108. The clipboard 104 has an upper half 114 and a lower half 112 connected together with a hinge that allows the clipboard 104 to open and close. In the closed position, the upper surface 108 of the clipboard 104 supports the flexible mixing pad 100 and the clamp 106 secures the pad 100 to the support surface 108. The weight of the pad 100 and the “stickyness,” or high coefficient of friction, of the pad surface adjacent the support surface 108 also help to keep the pad 100 in place on the support device 104.

The clipboard 104 has an inside compartment 116 dimensioned to receive the mixing pad 100 for storage in the clipboard 104 when the clipboard 104 is in the closed position. The illustrated embodiment includes an inside compartment 116 that is bounded by inside walls 118, 120 that define a compartment 116 with inside dimensions equal to the outside dimensions of the flexible pad 100. In one embodiment, the inside walls 118, 120 have a height at least equal to the thickness of the flexible pad 100. In the illustrated embodiment, liquid silicone or other suitable material is poured or introduced into the inside compartment, which serves as a mold for the pad 100. After curing, the flexible pad 100 is removed from its storage in the inside compartment 116 when it is desired to use the pad 100 for mixing. A mixing pad 100 formed of silicone has a potential usable life of two years or more under moderate use. In one embodiment, the silicone is a two part mixture that includes a hardener. In various such embodiments the amount of hardener is adjusted to control the life of the mixing pad 100. By increasing the percentage of hardener, the resulting mixing pad 100 has a shorter serviceable life. In one such embodiment, the percentage of hardener is increased such that the resulting mixing pad 100 has a short life, for example, six months or less, which results in the requirement that the mixing pad 100 be periodically replaced due to degradation of the silicone. Such replacement may prevent the mixing pad 100 from being used beyond its serviceable life.

In various embodiments, the support surface 108, and the support device 104, is a plastic or other hard material. In still another embodiment, the support device 104 is a rigid, planar sheet, such as a standard, flat clipboard. In the illustrated embodiment, the mixing pad 100 is secured to the support surface 108 by a clamp 106.

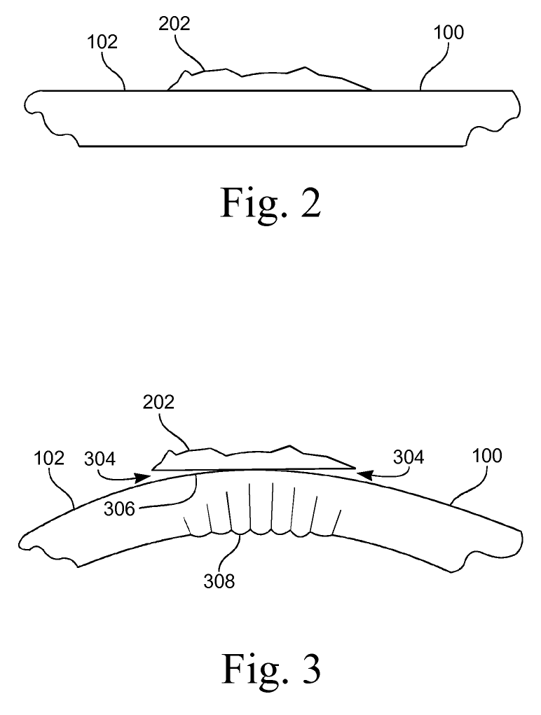

FIG. 2 illustrates a side view of the flexible mixing pad 100 with a compound 202 on the working surface 102. After working the compound 202 on the mixing pad 100, any compound 202 not used remains on the working surface 102 and hardens or cures. Such excess residue is illustrated as a clump of compound 202 in FIG. 2.

FIG. 3 illustrates a side view of the flexible mixing pad 100 in a flexed state with the cured compound 202 detached from the pad 100. After the compound 202 cures on the mixing pad 100, the pad 100 is bent or flexed and the compound 202 pops off the pad 100 because of the rigid, hard structure of the compound 202 and the anti-adhesive properties of the mixing pad 100. The pad 100 is placed in a flexed configuration in which the outer surface 306 stretches and the inner surface 308 bunches together. As the pad 100 bends, gaps 304 form under the outer edges of the cured compound 202 until the cured compound 202 is completely released from the outer, stretched surface 306, which is left clean and free of any compound 202. The resilient nature of the flexible mixing pad 100 allows the pad 100 to return substantially to its original, relaxed configuration having a flat working surface 102.

To clean the flexible mixing pad 100, the pad 100 is either removed from the support device 104 or left on the device 104. If removed from the support device 104, the pad is then grasped on opposing edges and forced into a flexed or bent configuration, such as illustrated in FIG. 3. If the pad 100 is left clamped to the support device 104, then the edge of the pad 100 opposite the clamp 106 is grasped and the pad 100 is then lifted and flexed until it assumes the configuration illustrated in FIG. 3. Because the pad 104 is resilient, no great force is required to place the pad 100 in the flexed or bent configuration. The flexible mixing pad 100 is flexed such that any cured compound 202 on the working surface 102 is released from the surface 102. Another method of cleaning the pad 100 is to run a putty knife over the surface 102 of the pad 100 to dislodge and release any cured compound 202. The flexible mixing pad 100 is readily cleaned of any dust, debris, or other contaminates by washing with soap and water and/or cleaning with a cloth.

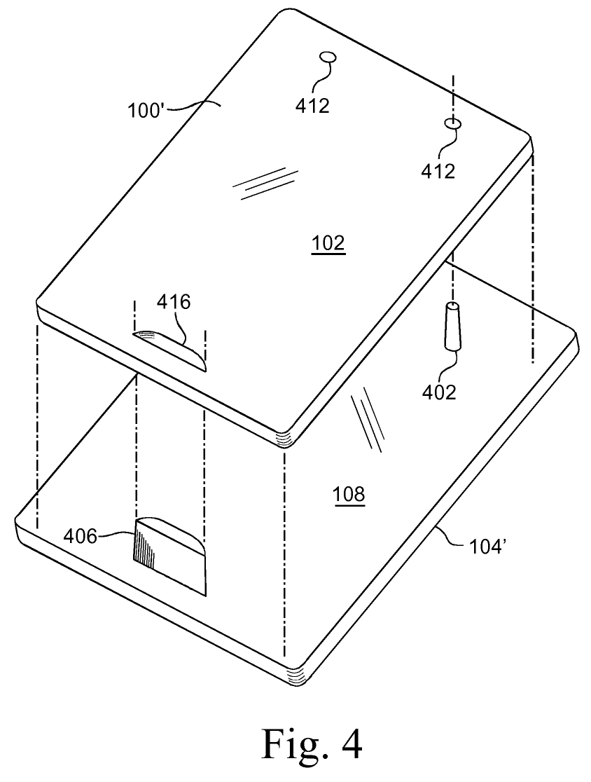

FIG. 4 illustrates an exploded perspective view of another embodiment of a flexible mixing pad 100′ and a support device 104′. The support device 104′ in the illustrated embodiment is a rigid board with a flat surface 108 and a pair of pegs 402 and a protruding member 406 extending from the flat surface 108. The flexible mixing pad 100′ in the illustrated embodiment has a flat working surface 102 and a pair of index holes 412 dimensioned and configured to receive the pegs 402 extending from the support device 104′. The mixing pad 100′ also includes an opening 406 dimensioned and configured to receive the protruding member 406 extending from the support device 104′.

With the mixing pad 100′ resting against the support surface 108, the pegs 402 engage the index holes 412 and the protruding member 406 engages the opening 416. The pegs 402 and protruding member 406 fix the pad 100′ to the support device 104′ and prevent the pad 100′ from moving laterally on the support surface 108 when shear stress is applied between the pad 100 and the support device 104′, such as when a compound is being worked on the working surface 102. Those skilled in the art will recognize that the number, configuration, and location of the pegs 402 and protruding members 406 may vary without departing from the spirit and scope of the present invention.

In one embodiment, the pegs 402 are conical. The cone-shape serves to wedge the pegs 402 in the holes 412, thereby providing an even more secure connection of the pad 100′ to the support device 104′.

The flexible mixing pad 100 includes various functions. The function of securing the mixing pad 100, 100′ to the support device 104, 104 is implemented, in one embodiment, by the clamp 106 attached to a clipboard 104. In another embodiment, the pad 100′ is secured to the support device 104′ by a plurality of pegs 402 and protrusions 406 that engage holes 412 and/or openings 416 in the pad 100′.

From the foregoing description, it will be recognized by those skilled in the art that a flexible mixing pad 100 has been provided. The mixing pad 100 is a thick, flat pad of a resilient material that has anti-adhesive properties. The pad 100 is attached to a support device 104 that has a support surface 108 that maintains the working surface 102 of the mixing pad 100 in a substantially planar configuration.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus providing a mixing surface for a compound, said apparatus comprising:
a pad having a work surface, said pad being flexible, said pad having a thickness sufficient to resist buckling, tearing, and gouging when the compound is worked on said work surface,
a support device having a support surface, said support surface being substantially planar, said support device having a compartment dimensioned and configured to receive said pad, said compartment having a cover wherein said pad is enclosed when received by said compartment,
a means for securing said pad to said support device wherein said work surface is positioned for working the compound.

2. The apparatus of claim 1 wherein said means for securing includes a clamp attached to said support device, said clamp configured to releasably receive a portion of said pad.

3. The apparatus of claim 1 wherein said means for securing includes a plurality of protrusions extending from said support surface of said support device, said means for securing further including a plurality of openings in said pad, said plurality of protrusions configured to releasably engage said plurality of openings.

4. The apparatus of claim 1 wherein said compartment includes sidewalls forming a mold dimensioned to produce a pad when a material is introduced into said compartment.

5. The apparatus of claim 1 wherein said pad has a surface having a high coefficient of friction when adjacent said support surface.

6. The apparatus of claim 1 wherein said pad is made of a silicone material.

7. An apparatus providing a mixing surface for a compound, said apparatus comprising:
a pad having a work surface, said pad being flexible, said pad having a thickness sufficient to resist buckling, tearing, and gouging when the compound is worked on said work surface;
a support device having a support surface, said support surface being substantially planar, said support surface being configured to receive a surface opposite said work surface of said pad; and
a securing device attached to said support device, said securing device releasably securing said pad to said support surface of said support device.

8. The apparatus of claim 7 wherein said support device having a compartment dimensioned and configured to receive said pad, said compartment having a cover wherein said pad is enclosed when received by said compartment,

9. The apparatus of claim 7 wherein said securing device includes a clamp attached to said support device, said clamp configured to releasably receive a portion of said pad.

10. The apparatus of claim 7 wherein said securing device includes a plurality of protrusions extending from said support surface of said support device, said securing device further including a plurality of openings in said pad, said plurality of protrusions configured to releasably engage said plurality of openings.

11. The apparatus of claim 7 wherein said pad has a surface having a high coefficient of friction when adjacent said support surface.

12. The apparatus of claim 7 wherein said pad is made of a silicone material.

13. The apparatus of claim 7 wherein said pad is reusable.

14. An apparatus providing a mixing surface for a compound, said apparatus comprising:
a pad having a work surface, said pad being flexible, said pad having a smooth tough surface that is resistant to buckling, tearing, and gouging when the compound is worked on said work surface, said pad having anti-adhesive properties with low chemical reactivity, said pad being reusable;
a support device having a support surface, said support surface being substantially planar, said support surface adjacent a surface opposite said work surface of said pad,
a securing device attached to said support device, said securing device securing said pad to said support surface of said support device.

15. The apparatus of claim 14 wherein said support device has a compartment dimensioned and configured to receive said pad, said compartment having a cover wherein said pad is enclosed when received by said compartment.

16. The apparatus of claim 14 wherein said securing device includes a clamp attached to said support device, said clamp configured to releasably receive a portion of said pad.

17. The apparatus of claim 14 wherein said securing device includes a plurality of protrusions extending from said support surface of said support device, said securing device further including a plurality of openings in said pad, said plurality of protrusions configured to releasably engage said plurality of openings.

18. The apparatus of claim 14 wherein said pad has a surface having a high coefficient of friction when adjacent said support surface.

19. The apparatus of claim 14 wherein said paid is releasably secured by said securing device.

20. The apparatus of claim 14 wherein said pad is made of a silicone material.
